(19) United States
(12) Patent Application Publication
(10) Pub. No.: US 2025/0038543 A1
(43) Pub. Date: Jan. 30, 2025

(54) APPARATUS AND METHOD FOR MAX CURRENT SHARING

(71) Applicant: AES Global Holdings PTE Ltd., Singapore (SG)

(72) Inventors: Shi Jie Deng, Shenzhen (CN); Peng Wu, Yueyang City (CN)

(21) Appl. No.: 18/709,213

(22) PCT Filed: Nov. 12, 2021
(86) PCT No.: PCT/CN2021/130353

§ 371 Date: May 19, 2023

(51) Int. Cl. H02J 3/46

(52) U.S. Cl. CPC H02J 3/46

(57) ABSTRACT

A power supply including three feedback loops: an inner voltage loop, an outer voltage loop, and a current sharing loop. The inner voltage loop is the primary regulation/conversion loop that generates the power supply output voltage. The outer voltage loop monitors the voltage at a second node that is remote relative to the power supply output which is compared to a reference. The output of the comparison is then filtered, limited, and then the output of the limiter is provided to a selector. The current sharing loop receives an indicator of output current for the power supply compared to a reference, which is the largest one of all paralleled supplies. The comparison is then filtered, limited, and then the output of the limiter is also provided to the selector. The selector output is used to offset the feedback parameter of the inner voltage loop.

### CROSS-REFERENCE TO RELATED APPLICATIONS

This application IS A 371 National Stage application and claims the benefit of and priority to PCT Application No. PCT/CN2021/130353, filed 12 Nov. 2021. The entire disclosure of the above application is incorporated herein by reference.

### TECHNICAL FIELD

Aspects of the disclosure are related to the field of power supply units, and in particular, to maintaining balanced current sharing among multiple power supplies connected in parallel in response to dynamic load changes.

### BACKGROUND

This section provides background information related to the present disclosure which is not necessarily prior art.

A power supply unit is an electrical device that supplies electric power to an electrical load. Indeed, power supply units typically have a power input connection, which receives energy in the form of electric current from a source, and one or more power output connections that deliver current to the load. The primary function of a power supply is to convert electric current from a source to a correct voltage, current, and frequency to power a load. Indeed, a power supply unit may perform a variety of functions, such as, but not limited to, power conversion, alternating current to direct current (AC-DC) or DC-DC conversion, adjusting voltage levels, and providing backup power during power grid outages. A power supply system typically includes multiple power sources (or power supply units) that provide power and power management functionality including load current sharing among the multiple power sources.

Unfortunately, conventional power supply systems suffer numerous deficiencies with respect to current sharing. For example, when multiple power supplies are connected in parallel to share the supply of a load current, and the load current dynamically changes relatively rapidly, mismatches of various parameters between power supplies may cause a poor current sharing response to these changes.

Saturation can also affect current sharing and limit dynamic performance. One or more errors lasting for a long interval (e.g., a saturation integral) may also lead to poor system transient response or vibration.

### SUMMARY

Embodiments of the disclosure are presented herein that overcome the aforementioned drawbacks.

One or more embodiments described herein, among other benefits, solve one or more of the foregoing or other problems in the art by providing systems, methods, and non-transitory computer readable media for balancing the current supplied by multiple power supplies connected in parallel. In some implementations, the technology described includes a power supply, comprising: an inner voltage control feedback loop to generate a power supply output voltage based on an inner loop feedback indicator that is based on the power supply output voltage; an outer voltage control loop to receive a remote power supply voltage indicator and to, based on the remote power supply voltage indicator, generate an outer voltage loop feedback indicator; a current sharing control loop to receive a current sharing indicator and to, based on the current sharing indicator, generate a current sharing loop feedback indicator; a feedback indicator selector to receive the outer voltage loop feedback indicator and the current sharing loop feedback indicator, and to output a one of the outer voltage loop feedback indicator and the current sharing loop feedback indicator as a selected feedback indicator that affects the power supply output voltage.

In some implementations, the technology described includes a power supply, comprising: an inner voltage control feedback loop to generate a power supply output voltage that is based feedback from the power supply output voltage; an outer voltage control loop to receive generate an outer voltage loop feedback indicator based on a remote power supply voltage; a current sharing control loop to generate a current sharing loop feedback indicator based on a current sharing indicator; a feedback indicator selector to select between the outer voltage loop feedback indicator and the current sharing loop feedback indicator to provide a selected feedback indicator that affects the power supply output voltage.

In some implementations, the technology described includes a method of operating a power supply, comprising: calculating an outer loop feedback indicator using an outer loop transfer function that includes a first anti-saturation integral calculation; calculating a current sharing loop feedback indicator using a current sharing loop transfer function that includes a second anti-saturation integral calculation; comparing the outer loop feedback indicator and the current sharing loop feedback indicator; based on the comparing, selecting a first loop feedback indicator to be provided to an inner feedback loop.

Additional features and advantages of the present application will be set forth in the description which follows, and in part will be obvious from the description, or may be learned by the practice of such example embodiments.

### BRIEF DESCRIPTION OF THE DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not considered to be limiting of its scope. Implementations will be described and explained with additional specificity and detail through the use of the accompanying drawings.

FIG. 1 is a block diagram illustrating a power supply unit and system.

FIG. 2 is a block diagram illustrating a current sharing power supply system.

FIG. 3 is a flowchart illustrating a method of operating a power supply.

FIG. 4 is a flowchart illustrating a method of adjusting an output voltage of a power supply.

FIG. 5 is a block diagram illustrating a computer system.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Example implementations are provided so that this disclosure will be thorough and will fully convey the scope to persons skilled in the art. Numerous specific details are set forth such as examples of specific components, devices, and methods, to provide a thorough understanding of implementations of the present disclosure. It will be apparent to those skilled in the art that specific details need not be employed, that example implementations may be embodied in many different forms and that neither should be construed to limit the scope of the disclosure. In some example implementations, well-known processes, well-known device structures, and well-known technologies are not described in detail.

The terminology used herein is for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In an embodiment, a power supply includes three feedback loops: an inner voltage loop, an outer voltage loop, and a current sharing loop. The inner voltage loop is the primary regulation/conversion loop that generates the power supply output voltage. The output voltage of the power supply, at the output node of the power supply, is the feedback parameter of the inner voltage loop.

The outer voltage loop monitors the voltage at a second node that is remote (e.g., at a node local to the load) relative to the power supply output. This second voltage is compared (e.g., subtracted from) a reference, the output of the comparison is then filtered (e.g., by a proportional-integral-derivative—PID—feedback block), limited, and then the output of the limiter is provided to a selector.

The current sharing loop receives an indicator of output current for the power supply compared (e.g., subtracted from) a reference, which is the largest one of all supplies, the comparison is then filtered (e.g., a PID feedback block), limited, and then the output of the limiter is also provided to the selector.

The selector outputs select the greater or the smaller of the outputs of the outer voltage loop limiter and the current sharing loop limiter. The output of the selector is used to offset the feedback parameter of the inner voltage loop thereby increasing or decreasing the output voltage of the power supply.

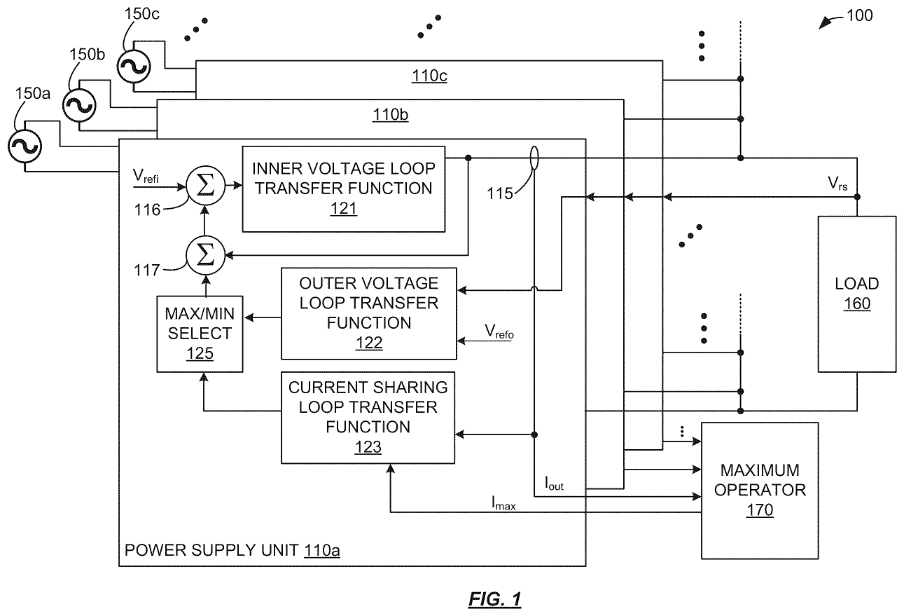

FIG. 1 is a block diagram illustrating a power supply system. In FIG. 1, power supply system 100 comprises power supply units 110a-110c, line inputs 150a-150c, load 160, and maximum operator 170. Power supply units 110a-110c receive line inputs 150a-150c, respectively. The power supply output and return (e.g., ground) terminals of power supplies 110a-110c are connected in parallel to share the provision of power supply current at a specified voltage to load 160.

Power supply unit 110a, as an example of power supplies 110a-110c, includes inner voltage loop transfer function 121, outer voltage loop transfer function 122, current sharing loop transfer function 123, selector 125, output current sense 115, and summation functions 116-117. The output of inner voltage loop transfer function is the output of power supply unit 110a and is coupled to a first terminal of load 160. In FIG. 1, selector 125 has two inputs. selector 125 functions to provide, at its output, the maximum (i.e., greater) or minimum (e.g., smaller) of the two values/indicators/variables provided to its inputs. For example, the selector 125 may be configured to provide the greatest value of inputs x and y (e.g., Max (x, y)). Alternatively, the selector 125 may be configured to provide the least value of inputs x and y Since there is a polar opposite transfer Max (x, y)=−Min (−x,−y), the implementation of either the Max or the Min functions results in the same function by inputs and output signals inversed.

An inner voltage feedback loop includes the output voltage of inner voltage loop transfer function 121 being fed back to summation function 117 for comparison to the output of the selector 125 (e.g., output of the selector 125 is subtracted from the sensed output voltage of power supply unit 110a). The output of summation function 117 is input to summation function 116 for comparison to a reference voltage V_{refi} (e.g., output of summation function 117 is subtracted from the reference voltage V_{refi}.) The output of summation function 116 is input to inner voltage loop transfer function 121 thereby forming a feedback loop (inner voltage feedback loop) that includes inner voltage loop transfer function 121 and summation functions 116-117. Inner voltage loop transfer function 121 may include one or more of proportional, integral, and derivative characteristics and/or functions together with a converter.

An outer voltage feedback loop includes the output voltage of inner voltage loop transfer function 121 being provided to a remote, relative to power supply unit 110a, node (e.g., power supply input node of load 160), a sensed voltage at the remote node, Vᵣₛ, is provided to outer voltage loop transfer function 122. Outer voltage loop transfer function 122 compares Vᵣₛ to an outer voltage loop reference voltage V_{refo}. The output of outer voltage loop transfer function 122, which is based on the comparison (e.g., subtraction) of Vᵣₛ and V_{refo}, is provided to a first input of selector 125. The output of selector 125 is provided to summation function 117 for comparison to the output voltage of power supply unit 110a. The output of summation function 117 is input to summation function 116 for comparison to a reference voltage V_{refi} (e.g., output of summation function 117 is subtracted from the reference voltage V_{refi}.) The output of summation function 116 is input to inner voltage loop transfer function 121. The output of inner voltage loop transfer function 121 is provided to load 160 thereby, when the output of outer voltage loop transfer function 122 is greater than the output of current sharing loop transfer function 123, forming a feedback loop (outer voltage feedback loop) that includes inner voltage loop transfer function 121, outer voltage loop transfer function 122, selector 125, and summation functions 116-117. Outer voltage loop transfer function 122 may include one or more of proportional, integral, derivative, and limiter characteristics and/or functions. In an embodiment, an integral function or characteristic of outer voltage loop transfer function 122 uses or implements an anti-integral saturation (a.k.a., anti-windup) characteristic. This may include, for example, an integration separation algorithm and a limit weakening integration algorithm.

A current sharing feedback loop includes the output current of power supply unit 110a being provided to load 160. The output current of inner voltage loop transfer function 121 is sensed by current sense 115 which provides an indicator of the output current Iₒᵤₜ to maximum operator 170 and current sharing loop transfer function 123. Maximum operator 170 receives output current indicators from all of the paralleled power supply units 110a-110c and selects the maximum current indicator to be provided back to all of the power supply units 110a-110c as the target (reference) output current Imax. Current sense 115 is operatively coupled to the output of power supply unit 110a, and inner voltage loop transfer function 121, in particular.

Current sense 115 may be any device, means, circuit etc. to sense the current flowing to/from power supply unit 110a. For example, current sense 115 may be a resistor coupled to an amplifier to provide a voltage that is proportional to the current being supplied by power supply unit 110a. In another example, current sense 115 may include a hall effect sensor. In another example, current sense 115 may include a coil electromagnetically coupled to the output of power supply unit 110a to measure the current being supplied by power supply unit 110a. In FIG. 1, current sense 115 is shown as being coupled to the output of power supply unit 110a. This is merely for illustration purposes. Current sense 115 may be coupled to, and/or sensing, the return current from load 160.

Current sharing loop transfer function 123 compares Iₒᵤₜ to reference Imax received from maximum operator 170. The output of current sharing loop transfer function 123, which is based on the comparison (e.g., subtraction) of Iₒᵤₜ and Imax, is provided to a second input of selector 125. The output of selector 125 is provided to summation function 117 for comparison to the output voltage of power supply unit 110a. The output of summation function 117 is input to summation function 116 for comparison to a reference voltage V_{refi} (e.g., output of summation function 117 is subtracted from the reference voltage V_{refi}.) The output of summation function 116 is input to inner voltage loop transfer function 121. The output current of inner voltage loop transfer function 121 is sensed by current sense 115 thereby, when the output of current sharing loop transfer function 123 is selected by selector 125, greater or less than the output of outer voltage loop transfer function 122, forming a feedback loop (current sharing feedback loop) that includes inner voltage loop transfer function 121, current sense 115, current sharing loop transfer function 123, selector 125, and summation functions 116-117. Current sharing loop transfer function 123 may include one or more of proportional, integral, derivative, and limiter characteristics and/or functions. In an embodiment, an integral function or characteristic of current sharing loop transfer function 123 uses and/or implements an anti-integral saturation (a.k.a., anti-windup) characteristic. This may include, for example, an integration separation algorithm and a limit weakening integration algorithm.

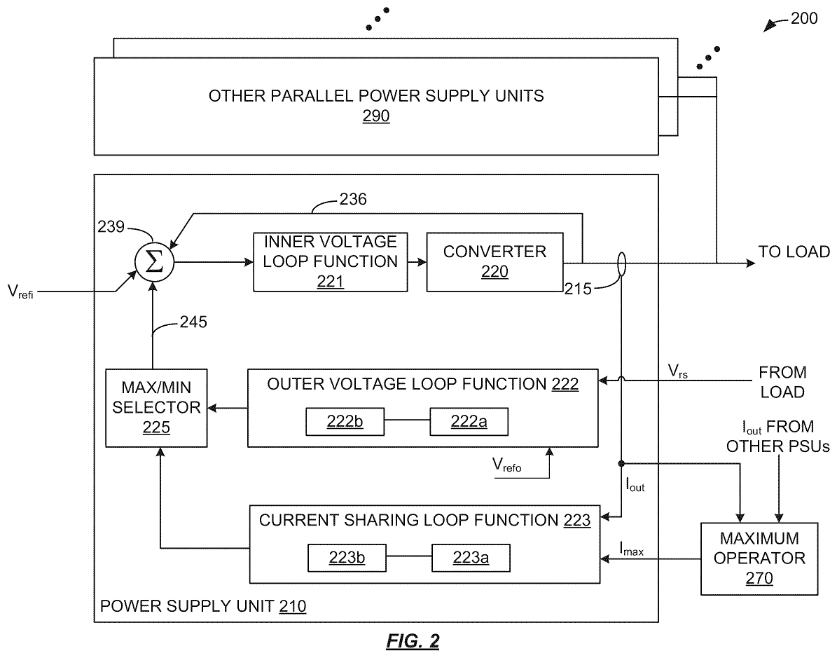

FIG. 2 is a block diagram illustrating a current sharing power supply system. In FIG. 2, power supply system 200 includes power supply unit 210, and power supply units 290. Power supply unit 210 is operatively connected in parallel with power supply units 290 to supply regulated power supply voltage and current to a load.

In FIG. 2, power supply unit 210 includes current sense 215, converter 220, inner voltage loop function 221, outer voltage loop function 222, current sharing loop function 223, selector 225, and summation function 239. Outer voltage loop function 222 includes integration function 222a and limiter function 222b. Current sharing loop function 223 includes integration function 223a and limiter function 223b. In an embodiment, one or more of integration function 222a and integration function 223a use and/or implements an anti-integral saturation (a.k.a., anti-windup) characteristic. This may include, for example, an integration separation algorithm and a limit weakening integration algorithm.

The output of summation function 239 is provided to inner voltage loop function 221. The output of inner voltage loop function 221 controls converter 220. Summation function 239 receives an inner voltage loop reference voltage V_{refi}. The output 236 of converter 220 is fed back to summation function 239 thereby forming an inner voltage feedback loop.

The output of converter 220 is provided to a load (not shown in FIG. 2). The voltage at the load Vᵣₛ is provided to outer voltage loop function 222. Outer voltage loop function also receives an outer loop reference voltage V_{refo}. Outer voltage loop function, after integrating 222a and limiter function 222b a signal that is based on Vᵣₛ and V_{refo}, provides an outer voltage loop error signal to a first input of selector 225. The output signal 245 of selector 225 is provided to summation function 239 thereby, when the outer voltage loop error signal is the greater of the two inputs to selector 225, forming an outer voltage feedback loop.

Current sense 215 provides a signal (Iₒᵤₜ) that is proportional to the output current of power supply unit 210 to current sharing loop function 223. Current sharing loop function 223 receives a reference signal Imax from maximum operator 270. The Imax is the maximum of Iₒᵤₜ among a group of parallel power supply units 210 and 290. Current sharing loop function 223, after integrating 223a and limiter function 223b a signal that is based on Iₒᵤₜ and Imax, provides a current sharing output signal to a second input of selector 225. The output signal 245 of selector 225 is provided to summation function 239 thereby, wherein the current sharing loop output signal is selected by selector 225 based on the Max or Min functions as described above, forming a current sharing feedback loop.

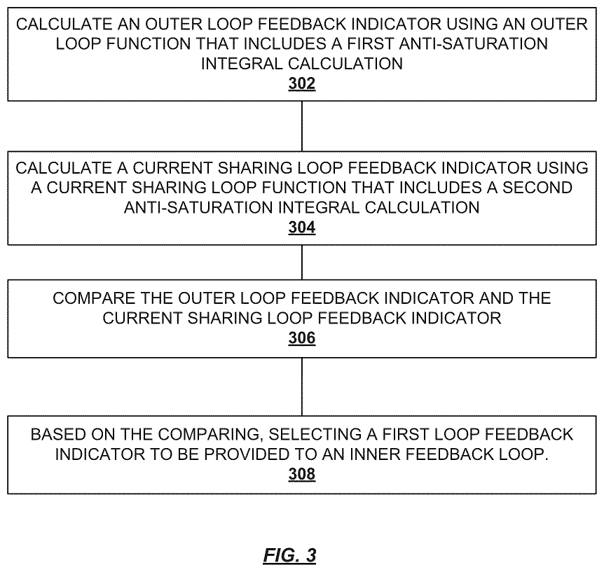

FIG. 3 is a flowchart illustrating a method of operating a power supply. One or more steps illustrated in FIG. 3 may be performed by, for example, power supply system 100, power supply system 200, and/or their components. An outer loop feedback indicator is calculated using an outer loop function that includes a first anti-saturation integral calculation (302). For example, outer voltage loop function 222, based on Vᵣₛ and V_{refo}, may calculate an outer voltage loop error signal, using an anti-saturation integration function 222a.

A current sharing loop feedback indicator is calculated using a current sharing loop function that includes a second anti-saturation integral calculation (304). For example, current sharing loop function 223, based on Iₒᵤₜ and Imax, may calculate a current sharing loop error signal, using an anti-saturation integration function 223a. The outer loop feedback indicator and the current sharing loop feedback indicator are compared (306). For example, selector 225 may compare outer voltage loop output signal the current sharing loop output signal to determine which of the outer voltage loop output signal and the current sharing loop output signal is selected.

Based on the comparing, a first loop feedback indicator is selected to be provided to an inner feedback loop (308). For example, selector 225 selects one of the outer voltage loop output signal or the current sharing loop output signal as an offset signal 245 that is provided to summation function 239 of the inner voltage feedback loop of power supply unit 210.

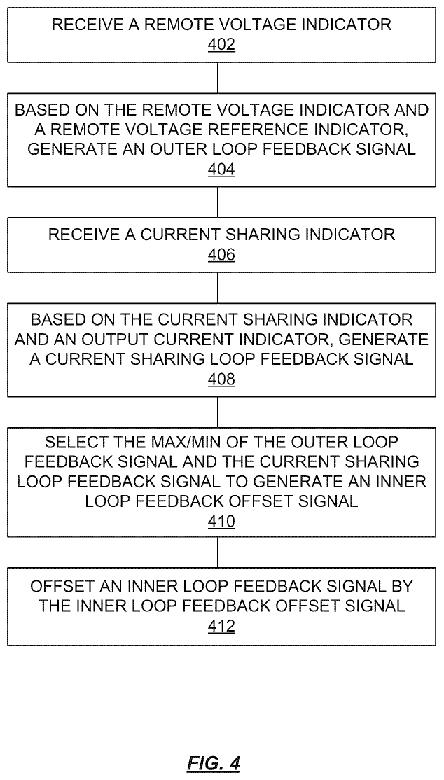

FIG. 4 is a flowchart illustrating a method of adjusting an output voltage of a power supply. One or more steps illustrated in FIG. 4 may be performed by, for example, power supply system 100, power supply system 200, and/or their components. A remote voltage indicator is received (402). For example, outer voltage loop function 222, may receive Vᵣₛ which is an indicator of the voltage being provided to the load coupled to power supply unit 210.

Based on the remote voltage indicator and a remote voltage reference indicator, an outer loop feedback signal is generated (404). For example, outer voltage loop function 222 may, based on Vᵣₛ and V_{refo}, calculate an outer voltage loop error signal using integration function 222a and limiter function 222b.

A current sharing indicator is received (406). For example, current sharing loop function 223, may receive Imax which is an indicator of the current power supply unit 210 should be providing to the load coupled to power supply unit 210. Based on the current sharing indicator and an output current indicator, a current sharing loop feedback signal is generated (408). For example, current sharing loop function 223 may, based on Iₒᵤₜ and Imax, calculate a current sharing loop error signal using integration function 223a and limiter function 223b.

The signal of the outer loop feedback signal or the current sharing loop feedback signal is selected to generate an inner loop feedback offset signal (410). For example, selector 225 may select one of the outer voltage loop output signal and the current sharing loop output signal as an offset signal 245 that is provided to summation function 239. The inner loop feedback signal is offset by the inner loop feedback offset signal (412). For example, summation function 239 may subtract offset signal 245 from the other inputs to summation function 239 in order to offset the output of summation function 239 that is provided to inner voltage loop function 221.

In an embodiment, computer system 500 and/or its components include circuits, software, and/or data that implement, or are used to implement, the methods, systems and/or devices illustrated in the Figures, the corresponding discussions of the Figures, and/or are otherwise taught herein. The methods described above may also be stored on a non-transitory computer readable medium. Devices, circuits, and systems described herein may be implemented using computer-aided design tools available in the art and embodied by computer-readable files containing software descriptions of such circuits. This includes, but is not limited to, one or more elements of power supply system 100, power supply system 200, and/or their components. These software descriptions may be: behavioral, register transfer, logic component, transistor, and layout geometry-level descriptions.

Data formats in which such descriptions may be implemented are stored on a non-transitory computer readable medium include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Physical files may be implemented on non-transitory machine-readable media such as: 4 mm magnetic tape, 8 mm magnetic tape, 3½-inch floppy media, CDs, DVDs, hard disk drives, solid-state disk drives, solid-state memory, flash drives, and so on.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), multi-core processors, graphics processing units (GPUs), etc.

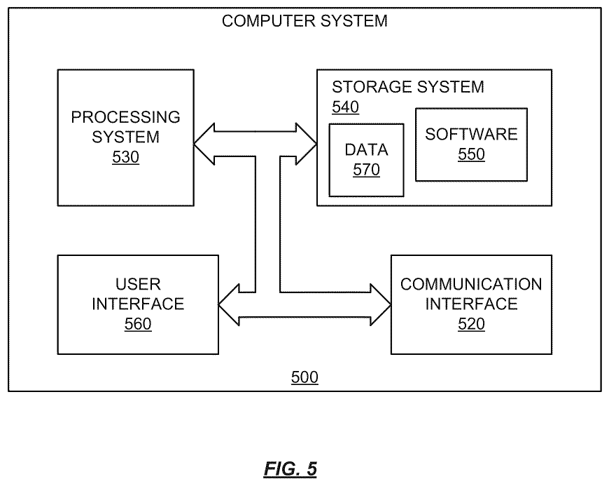

FIG. 5 illustrates a block diagram of an example computer system. Computer system 500 includes communication interface 520, processing system 530, storage system 540, and user interface 560. Processing system 530 is operatively coupled to storage system 540. Storage system 540 stores software 550 and data 570. Processing system 530 is operatively coupled to communication interface 520 and user interface 560. Computer system 500 may comprise a programmed general-purpose computer. Computer system 500 May include a microprocessor. Computer system 500 may comprise programmable or special purpose circuitry. Computer system 500 may be distributed among multiple devices, processors, storage, and/or interfaces that together comprise elements 520-570.

Communication interface 520 may comprise a network interface, modem, port, bus, link, transceiver, or other communication device. Communication interface 520 may be distributed among multiple communication devices. Processing system 530 may comprise a microprocessor, microcontroller, logic circuit, or other processing device. Processing system 530 may be distributed among multiple processing devices. User interface 560 may comprise a keyboard, mouse, voice recognition interface, microphone and speakers, graphical display, touch screen, or other type of user interface device. User interface 560 may be distributed among multiple interface devices. Storage system 540 may comprise a disk, tape, integrated circuit, RAM, ROM, EEPROM, flash memory, network storage, server, or other memory function. Storage system 540 may include computer readable medium. Storage system 540 may be distributed among multiple memory devices.

Processing system 530 retrieves and executes software 550 from storage system 540. Processing system 530 may retrieve and store data 570. Processing system 530 may also retrieve and store data via communication interface 520. Processing system 550 may create or modify software 550 or data 570 to achieve a tangible result. Processing system may control communication interface 520 or user interface 560 to achieve a tangible result. Processing system 530 may retrieve and execute remotely stored software via communication interface 520.

Software 550 and remotely stored software may comprise an operating system, utilities, drivers, networking software, and other software typically executed by a computer system. Software 550 may comprise an application program, applet, firmware, or other form of machine-readable processing instructions typically executed by a computer system. When executed by processing system 530, software 550 or remotely stored software may direct computer system 500 to operate as described herein.

Implementations discussed herein include, but are not limited to, the following examples:

Example 1: A power supply, comprising: an inner voltage control feedback loop to generate a power supply output voltage based on an inner loop feedback indicator that is based on the power supply output voltage; an outer voltage control loop to receive a remote power supply voltage indicator and to, based on the remote power supply voltage indicator, generate an outer voltage loop feedback indicator; a current sharing control loop to receive a current sharing indicator and to, based on the current sharing indicator, generate a current sharing loop feedback indicator; and a feedback indicator selector to receive the outer voltage loop feedback indicator and the current sharing loop feedback indicator, and to output a one of the outer voltage loop feedback indicator and the current sharing loop feedback indicator as a selected feedback indicator that affects the power supply output voltage.

Example 2: The power supply of claim 1, wherein the feedback indicator selector selects a greater one of the outer voltage loop feedback indicator and the current sharing loop feedback indicator.

Example 3: The power supply of claim 2, wherein the inner voltage control feedback loop further comprises: a summation function to combine the inner loop feedback indicator and the greater one of the outer voltage loop feedback indicator and the current sharing loop feedback indicator.

Example 4: The power supply of claim 3, wherein at least a portion of the inner voltage control feedback loop, the outer voltage control loop, and the current sharing control loop are implemented in executing firmware.

Example 5: The power supply of claim 3, wherein at least a portion of the inner voltage control feedback loop, the outer voltage control loop, and the current sharing control loop are implemented using analog circuitry.

Example 6: The power supply of claim 3, wherein when the power supply is operating as a master power supply the current sharing control loop does not affect the power supply output voltage directly.

Example 7: The power supply of claim 3, wherein the current sharing control loop affects the power supply output voltage when the power supply is operating as a slave power supply.

Example 8: A power supply, comprising: an inner voltage control feedback loop to generate a power supply output voltage that is based feedback from the power supply output voltage; an outer voltage control loop to receive generate an outer voltage loop feedback indicator based on a remote power supply voltage; and a current sharing control loop to generate a current sharing loop feedback indicator based on a current sharing indicator; a feedback indicator selector to select between the outer voltage loop feedback indicator and the current sharing loop feedback indicator to provide a selected feedback indicator that affects the power supply output voltage.

Example 9: The power supply of claim 8, wherein the feedback indicator selector selects a greater one of the outer voltage loop feedback indicator and the current sharing loop feedback indicator.

Example 10: The power supply of claim 9, wherein the inner voltage control feedback loop further comprises: a summation function to combine an inner loop feedback indicator and the greater one of the outer voltage loop feedback indicator and the current sharing loop feedback indicator.

Example 11: The power supply of claim 10, wherein at least a portion of the inner voltage control feedback loop, the outer voltage control loop, and the current sharing control loop are implemented in executing firmware.

Example 12: The power supply of claim 10, wherein at least a portion of the inner voltage control feedback loop, the outer voltage control loop, and the current sharing control loop are implemented using analog circuitry.

Example 13: The power supply of claim 12, wherein when the power supply is operating as a master power supply the current sharing control loop does not affect the power supply output voltage.

Example 14: The power supply of claim 12, wherein the current sharing control loop affects the power supply output voltage when the power supply is operating as a slave power supply.

Example 15: A method of operating a power supply, comprising: calculating an outer loop feedback indicator using an outer loop transfer function that includes a first anti-saturation integral calculation; calculating a current sharing loop feedback indicator using a current sharing loop transfer function that includes a second anti-saturation integral calculation; comparing the outer loop feedback indicator and the current sharing loop feedback indicator; and based on the comparing, selecting a first loop feedback indicator to be provided to an inner feedback loop.

Example 16: The method of claim 15, further comprising: based on the first loop feedback indicator, adjusting an output voltage of the power supply.

Example 17: The method of claim 16, wherein the outer loop feedback indicator is based on a remote power supply voltage.

Example 18: The method of claim 17, further comprising: receiving, from current sharing control circuitry, a current sharing loop feedback indicator.

Example 19: The method of claim 18, wherein the current sharing loop feedback indicator is based on a current being supplied by another power supply connected in parallel with the power supply.

Example 20: The method of claim 19, wherein an inner loop feedback indicator and the first loop feedback indicator are combined in an inner loop feedback path.

Example 21: The power supply of claim 1, wherein the feedback indicator selector selects a minimum one of the outer voltage loop feedback indicator and the current sharing loop feedback indicator.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A power supply, comprising:
an inner voltage control feedback loop to generate a power supply output voltage based on an inner loop feedback indicator that is based on the power supply output voltage;
an outer voltage control loop to receive a remote power supply voltage indicator and to, based on the remote power supply voltage indicator, generate an outer voltage loop feedback indicator;
a current sharing control loop to receive a current sharing indicator and to, based on the current sharing indicator, generate a current sharing loop feedback indicator; and
a feedback indicator selector to receive the outer voltage loop feedback indicator and the current sharing loop feedback indicator, and to output a one of the outer voltage loop feedback indicator and the current sharing loop feedback indicator as a selected feedback indicator that affects the power supply output voltage.

2. The power supply of claim 1, wherein the feedback indicator selector selects a greater one of the outer voltage loop feedback indicator and the current sharing loop feedback indicator.

3. The power supply of claim 2, wherein the inner voltage control feedback loop further comprises:
a summation function to combine the inner loop feedback indicator and the greater one of the outer voltage loop feedback indicator and the current sharing loop feedback indicator.

4. The power supply of claim 3, wherein at least a portion of the inner voltage control feedback loop, the outer voltage control loop, and the current sharing control loop are implemented in executing firmware.

5. The power supply of claim 3, wherein at least a portion of the inner voltage control feedback loop, the outer voltage control loop, and the current sharing control loop are implemented using analog circuitry.

6. The power supply of claim 3, wherein when the power supply is operating as a master power supply the current sharing control loop does not affect the power supply output voltage directly.

7. The power supply of claim 3, wherein the current sharing control loop affects the power supply output voltage when the power supply is operating as a slave power supply.

8. A power supply, comprising:
an inner voltage control feedback loop to generate a power supply output voltage that is based feedback from the power supply output voltage;
an outer voltage control loop to receive generate an outer voltage loop feedback indicator based on a remote power supply voltage; and
a current sharing control loop to generate a current sharing loop feedback indicator based on a current sharing indicator;
a feedback indicator selector to select between the outer voltage loop feedback indicator and the current sharing loop feedback indicator to provide a selected feedback indicator that affects the power supply output voltage.

9. The power supply of claim 8, wherein the feedback indicator selector selects a greater one of the outer voltage loop feedback indicator and the current sharing loop feedback indicator.

10. The power supply of claim 9, wherein the inner voltage control feedback loop further comprises:
a summation function to combine an inner loop feedback indicator and the greater one of the outer voltage loop feedback indicator and the current sharing loop feedback indicator.

11. The power supply of claim 10, wherein at least a portion of the inner voltage control feedback loop, the outer voltage control loop, and the current sharing control loop are implemented in executing firmware.

12. The power supply of claim 10, wherein at least a portion of the inner voltage control feedback loop, the outer voltage control loop, and the current sharing control loop are implemented using analog circuitry.

13. The power supply of claim 12, wherein when the power supply is operating as a master power supply the current sharing control loop does not affect the power supply output voltage.

14. The power supply of claim 12, wherein the current sharing control loop affects the power supply output voltage when the power supply is operating as a slave power supply.

15. A method of operating a power supply, comprising:
calculating an outer loop feedback indicator using an outer loop transfer function that includes a first anti-saturation integral calculation;
calculating a current sharing loop feedback indicator using a current sharing loop transfer function that includes a second anti-saturation integral calculation;
comparing the outer loop feedback indicator and the current sharing loop feedback indicator; and
based on the comparing, selecting a first loop feedback indicator to be provided to an inner feedback loop.

16. The method of claim 15, further comprising:
based on the first loop feedback indicator, adjusting an output voltage of the power supply.

17. The method of claim 16, wherein the outer loop feedback indicator is based on a remote power supply voltage.

18. The method of claim 17, further comprising:
receiving, from current sharing control circuitry, the current sharing loop feedback indicator.

19. The method of claim 18, wherein the current sharing loop feedback indicator is based on a current being supplied by another power supply connected in parallel with the power supply.

20. The method of claim 19, wherein an inner loop feedback indicator and the first loop feedback indicator are combined in an inner loop feedback path.
